(19) United States
(12) Patent Application Publication
(10) Pub. No.: US 2017/0194094 A1
(43) Pub. Date: Jul. 6, 2017

(54) RFeB SYSTEM MAGNET AND METHOD FOR PRODUCING RFeB SYSTEM MAGNET

(71) Applicants: INTERMETALLICS CO., LTD., Nakatsugawa-shi, Gifu (JP); DAIDO STEEL CO., LTD., Nagoya-shi, Aichi (JP)

(72) Inventors: Tetsuhiko MIZOGUCHI, Nagoya-shi (JP); Masato SAGAWA, Nagoya-shi (JP)

(73) Assignees: INTERMETALLICS CO., LTD., Nakatsugawa-shi, Gifu (JP); DAIDO STEEL CO., LTD., Nagoya-shi, Aichi (JP)

(21) Appl. No.: 15/315,214

(22) PCT Filed: May 25, 2015
(86) PCT No.: PCT/JP2015/064886

§ 371 Date: Nov. 30, 2016

(30) Foreign Application Priority Data
Jun. 2, 2014 (JP) 2014-113868

(51) Int. Cl. H01F 41/02; C22C 38/10; C22C 38/02; C22C 38/06; C23C 10/30; C22C 38/00

(52) U.S. Cl. CPC H01F 41/0293; C23C 10/30; C22C 38/00; C22C 38/02; C22C 38/06; C22C 38/10

(57) ABSTRACT

An RFeB system sintered magnet wherein heavy rare-earth element RH which is at least one kind of rare-earth element selected from Dy, Tb and Ho is diffused into base material through the grain boundaries of base material made of a sintered compact of an RFeB system magnet containing RL, Fe and B, where RL represents a light rare-earth element which is at least one kind of rare-earth element selected from Nd and Pr, wherein: size of the RFeB system sintered magnet at smallest-size portion is greater than 3 mm; the amount of heavy rare-earth element RH contained in RFeB system sintered magnet divided by volume of RFeB system sintered magnet is ≧25 mg/cm3; and the difference between local coercivity at the surface of the smallest-size portion and in the central region of the smallest-size portion is equal to or less than 15% of local coercivity at the surface.

### TECHNICAL FIELD

The present invention relates to an RFeB system magnet containing R (rare-earth element), Fe and B as well as a method for producing such a magnet. In particular, the present invention relates to an RFeB system magnet which has been subjected to a grain boundary diffusion treatment in which at least one kind of rare-earth element selected from the group of Dy, Tb and Ho (the at least one kind of element selected from the group of Dy, Tb and Ho is hereinafter called the “heavy rare-earth element R^{H}”) is diffused through the grain boundaries of the main phase grains into regions near the surfaces of those main phase grains, where the main phase grains contain, as the principal rare-earth element R, at least one kind of element selected from the group of Nd and Pr (the at least one kind of element selected from the group of Nd and Pr is hereinafter called the “light rare-earth element R^{L}”), as well as a method for producing such a magnet.

### BACKGROUND ART

An RFeB system sintered magnet is a permanent magnet produced by orienting and sintering a powder of RFeB system alloy. The RFeB system sintered magnet, which was discovered in 1982 by Sagawa et al., is characterized in that it has far better magnetic characteristics than the previously known permanent magnets and yet can be produced from comparatively abundant and inexpensive materials, i.e. rare earths, iron and boron.

It is expected that RFeB system sintered magnets will be increasingly in demand in the future as permanent magnets for motors used in hybrid cars and electric cars as well as for other applications. Automobiles must be designed for use under extreme loading conditions, and accordingly, their motors also need to be guaranteed to operate under high-temperature environments (e.g. 180° C.). Therefore, RFeB system sintered magnets which have a high level of coercivity H_{cj} that can suppress the decrease in magnetization (magnetic force) due to an increase in the temperature have been in demand. It is commonly known that the coercivity H_{cj} of an RFeB system sintered magnet increases with an increase in the content of the heavy rare-earth element R^{H}. However, increasing the content of the heavy rare-earth element R^{H} lowers the residual magnetic flux density Bᵣ of the RFeB system sintered magnet as well as decreases the maximum energy product (BH)ₘₐₓ. Furthermore, heavy rare-earth elements are scarce and expensive materials. Accordingly, the amount of use of R^{H} should preferably be as small as possible.

The coercivity H_{cj} is the power to withstand the inversion of magnetization when a magnetic field in an opposite direction to the direction of magnetization is applied to the magnet. It is generally considered that the heavy rare-earth element R^{H} prevents the magnetization inversion and thereby produces the effect of increasing the coercivity H_{cj}. A close look at the phenomenon of magnetization inversion in a magnet reveals the characteristic nature that the inversion of magnetization initially occurs in a region near the grain boundary of the main phase grain and subsequently spreads into deeper regions in the main phase grain. This means that preventing the initial occurrence of the magnetization inversion in the grain boundary is effective for preventing magnetization inversion over the entire magnet. Accordingly, it is preferable to localize the heavy rare-earth element R^{H} in near-surface regions of the main phase grains (or in the vicinity of the grain boundaries) of the RFeB system sintered magnet (i.e. to make the element scarce in the inner regions of the main phase grains and abundant in their near-surface regions) in order to minimize the amount of use of the element.

Patent Literature 1 discloses a grain boundary diffusion treatment in which an adhesion material containing a powder of alloy including a heavy rare-earth element R^{H} as one of its components is adhered to the surface of a base material made of a sintered compact of an NdFeB system magnet using Nd as the rare-earth element R, and the application material is subsequently heated to a predetermined temperature to diffuse the heavy rare-earth element R^{H} through the grain boundaries of the base material into the same base material. In this base material, a rare-earth-rich phase having a higher rare-earth (Nd) content than the main phase grain is present in the grain boundaries. This rare-earth-rich phase melts due to the heating process in the grain boundary diffusion treatment, helping the heavy rare-earth element R^{H} diffuse into the base material. By the grain boundary diffusion treatment, the heavy rare-earth element R^{H} can be localized in the near-surface regions of the main phase grains of the NdFeB system sintered magnet. Consequently, the decrease in the residual magnetic flux density Bᵣ and maximum energy product (BH)ₘₐₓ is suppressed, so that an RFeB system sintered magnet with a high level of coercivity H_{cj} can be obtained.

In Patent Literature 1, it is claimed that the amount of carbon which is present as an impurity in the base material should be as small as possible. The reason for this is because the carbon is localized in the grain boundaries in the base material (particularly, in the grain boundary triple point surrounded by three or more main phase grains), impeding the melting of the grain boundaries in the heating process during the grain boundary diffusion treatment. Accordingly, decreasing the amount of carbon in the base material facilitates the diffusion of the heavy rare-earth element R^{H} into the base material.

### CITATION LIST

### Patent Literature

Patent Literature 1: WO 2013/100010 A

Patent Literature 2: JP 2006-019521 A

### SUMMARY OF INVENTION

### Technical Problem

The present inventors have conduced detailed research on RFeB system sintered magnets produced by a conventional grain boundary diffusion treatment method. The result demonstrated that the coercivity of a single magnet is not uniform within the entire magnet; actually, the coercivity is locally high in some regions and low in other regions. More specifically, among the RFeB system sintered magnets produced by the conventional grain boundary diffusion treatment method, the magnets whose “smallest-size portion” (which is the portion having the smallest breadth in the base material; i.e. the thickness of the RFeB system sintered magnet) had a comparatively small size of 3 mm or less had an almost uniform coercivity distribution since the heavy rare-earth element R^{H} could spread fully over the entire grain boundaries and surfaces of the main phase grains, whereas the magnets whose smallest-size portion exceeded 3 mm had a non-uniform distribution of coercivity since the heavy rare-earth element R^{H} did not sufficiently spread through to the grain boundaries and the surfaces of the main phase grains in the central region of the smallest-size portion. If such a portion with low coercivity is locally present, that portion cannot withstand magnetization inversion when subjected to an opposite magnetic field during the use of the RFeB system sintered magnet, so that the average magnetization of the entire RFeB system sintered magnet becomes low.

The problem to be solved by the present invention is to provide an RFeB system sintered magnet which has a high and uniform level of coercivity over the entirety of the single magnet even if the magnet is comparatively thick, as well as a method for producing such a magnet.

### Solution to Problem

The RFeB system sintered magnet according to the present invention is an RFeB system sintered magnet in which a heavy rare-earth element R^{H} which is at least one kind of rare-earth element selected from the group of Dy, Tb and Ho is diffused into a base material through the grain boundaries of the same base material made of a sintered compact of an RFeB system magnet containing R^{L}, Fe and B, where R^{L} represents a light rare-earth element which is at least one kind of rare-earth element selected from the group of Nd and Pr, the magnet characterized in that:

the size of the RFeB system sintered magnet at a smallest-size portion is greater than 3 mm;

the amount of heavy rare-earth element R^{H} contained in the RFeB system sintered magnet divided by the volume of the RFeB system sintered magnet is equal to or greater than 25 mg/cm³; and

the difference between a local coercivity at the surface of the smallest-size portion and a local coercivity in the central region of the smallest-size portion is equal to or less than 15% of the local coercivity at the surface.

In the present invention, the “local coercivity” is the coercivity per unit volume within the RFeB system sintered magnet.

In the RFeB system sintered magnet according to the present invention, the amount of heavy rare-earth element R^{H} contained in the RFeB system sintered magnet produced by a grain boundary diffusion treatment divided by the volume of the RFeB system sintered magnet is made to be equal to or higher than 25 mg/cm³. According to this configuration, R^{H} is spread over the entire grain boundaries and surfaces of the main phase grains in the RFeB system sintered magnet. As a result, the local coercivity becomes roughly uniform over the entire RFeB system sintered magnet, with its difference from the value at the surface of the magnet being equal to or less than 15% at any location within the magnet.

In the process of producing the RFeB system sintered magnet according to the present invention, an adhesion material containing a heavy rare-earth element R^{H} may be used in a similar manner to the conventional method in order to perform the process of diffusing the heavy rare-earth element R^{H} into the base material. Normally, the adhesion material is eventually removed after this process. Accordingly, the aforementioned size and volume of the RFeB system sintered magnet as well as the amount of heavy rare-earth element R^{H} contained in the magnet are the values concerned with only the RFeB system sintered magnet exclusive of the part corresponding to the adhesion material.

The RFeB system sintered magnet production method according to the present invention is characterized by:

a) a base material production process in which a base material made of a sintered compact of an RFeB system magnet containing R^{L}, Fe and B is produced, where R^{L} represents a light rare-earth element which is at least one kind of rare-earth element selected from the group of Nd and Pr, and the size of the sintered compact at a smallest-size portion is greater than 3 mm; and

b) a grain boundary diffusion process in which a grain boundary diffusion treatment is performed including the step of adhering, to the surface of the base material, an adhesion material containing a heavy rare-earth element R^{H} which is at least one kind of rare-earth element selected from the group of Dy, Tb and Ho, and the step of heating the adhesion material, where the amount of heavy rare-earth element R^{H} contained in the adhesion material is controlled so that the amount of heavy rare-earth element R^{H} contained in the RFeB system sintered magnet divided by the volume of the same RFeB system sintered magnet after the grain boundary diffusion treatment becomes equal to or greater than 25 mg/cm³. By this method, the RFeB system sintered magnet according to the present invention can be produced.

The amount of heavy rare-earth element R^{H} contained in the adhesion material can be determined by a person skilled in the art by conducting a simple preliminary experiment. In the case where the heavy rare-earth element R^{H} in the adhesion material is entirely diffused into the RFeB system sintered magnet, the amount of heavy rare-earth element R^{H} contained in the adhesion material can be controlled so that the value obtained by dividing that amount by the volume of the RFeB system sintered magnet (or base material) becomes equal to or greater than 25 mg/cm³.

In the RFeB system sintered magnet production method according to the present invention, the content of the carbon in the base material should preferably be equal to or lower than 1000 ppm. Under this condition, the carbon will not impede the diffusion of the heavy rare-earth element R^{H} through the grain boundaries as well as over the surfaces of the main phase grains in the RFeB system sintered magnet in the grain boundary diffusion process. Since the grain boundary diffusion treatment is performed at a lower temperature than the sintering temperature as well as in a vacuum or inert-gas atmosphere, the carbon content barely changes before and after the grain boundary diffusion treatment. This fact has also been experimentally confirmed. Accordingly, an RFeB system sintered magnet produced from a base material whose carbon content is equal to or lower than 1000 ppm also has a carbon content of equal to or lower than 1000 ppm.

In the RFeB system sintered magnet production method according to the present invention, the base material should preferably be produced by filling a mold with an alloy powder containing the light rare-earth element R^{L}, Fe and B as the raw material, orienting the alloy powder by applying a magnetic field without applying mechanical pressure for the shaping, and sintering the alloy powder by heating the same powder as contained in the mold without applying mechanical pressure for the shaping (see Patent Literature 2). Such a method of producing an RFeB system sintered magnet without applying mechanical pressure for the shaping is hereinafter called the “PLP (press-less process)” method. The PLP method does not require a pressing machine and enables the downsizing of the equipment as compared to the pressing method, making it easier to place the entire piece of equipment in an oxygen-free atmosphere. Accordingly, as compared to the pressing method, the particles of the alloy powder are less likely to be oxidized in the production of the sintered magnet. This allows a decrease of the average particle size (and an increase in the total surface area of the particles in the entire alloy powder). The decrease in the average particle size of the alloy powder results in a corresponding decrease in the average grain size of the microcrystal in the eventually obtained sintered magnet. Therefore, a magnetic domain with inverted magnetization is less likely to be formed by an application of an external magnetic field. Thus, the level of coercivity is even more increased.

### Advantageous Effects of the Invention

With the present invention, an RFeB system sintered magnet having a high and uniform level of coercivity over the entire magnet can be obtained. Therefore, neither the local inversion of magnetization nor the consequent decrease in the magnetization occurs when the RFeB system sintered magnet is in use.

### BRIEF DESCRIPTION OF DRAWINGS

FIG. 1 is a schematic diagram showing one embodiment of the method for producing an RFeB system sintered magnet according to the present invention.

FIG. 2A is a perspective view showing one example of the base material of an RFeB system sintered magnet, and FIG. 2B is a vertical sectional view showing another example,

FIGS. 3A and 3B are diagrams illustrating a method of cutting out RFeB system sintered magnet pieces in order to measure the local coercivity in the RFeB system sintered magnet.

FIG. 4 is a graph showing the result of a measurement of the local coercivity (the coercivity of each RFeB system sintered magnet piece) in the RFeB system sintered magnets of the present and comparative examples.

FIG. 5 is a graph showing the relationship among the overall coercivity, local coercivity at the surface, and average of the local coercivity over the entire thickness of the RFeB system sintered magnets of the present and comparative examples.

FIG. 6 is a graph showing the result of a measurement of the overall coercivity in RFeB system sintered magnets of the present and comparative examples with different amounts of an application material (paste) applied.

### DESCRIPTION OF EMBODIMENTS

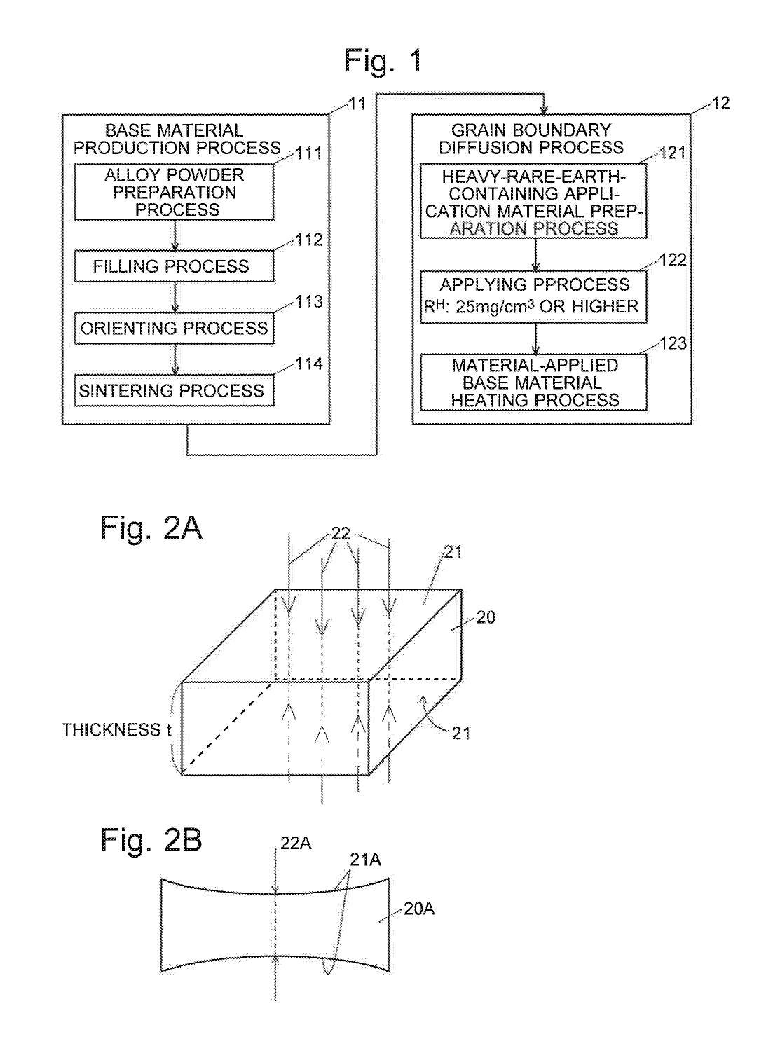

An embodiment of the RFeB system sintered magnet and its production method according to the present invention is hereinafter described using FIGS. 1-6.

Initially, using FIG. 1, the embodiment of the method for producing an RFeB system sintered magnet is described. The method according to the present embodiment includes two major processes: the base material production process 11 and grain boundary diffusion process 12.

In the base material production process 11, although it is possible to use the so-called “pressing method” which includes the step of applying mechanical pressure to an alloy powder as the raw material to produce a compact of the alloy powder, it is more preferable to use the PLP method in order to achieve a higher level of coercivity. The following description deals with the case of producing the base material by the PLP method.

The base material production process 11 using the PLP method is subdivided into the alloy powder preparation process 111, filling process 112, orienting process 113, and sintering process 114 (FIG. 1).

In the alloy powder preparation process 111, a lump of alloy containing a light rare-earth element R^{L}, Fe and B is pulverized to prepare an alloy powder as the raw material for the RFeB system sintered magnet. In this process, a lump of alloy produced by strip casting (SC) should preferably be used (which is hereinafter called the “SC alloy lump”). The SC alloy lump is produced by rapidly cooling a molten metallic material by pouring it onto a rotating drum. The lump produced by this method has laminar rare-earth-rich phases formed inside. By pulverizing this SC alloy lump, an alloy powder composed of powder particles of the main phase with fine powder of rare-earth-rich phase adhered to their surfaces is obtained. For example, the pulverization can be performed in two stages: The first stage is the coarse pulverization by hydrogen pulverization in which the SC alloy lump is exposed to a hydrogen gas atmosphere to make the SC alloy lump occlude hydrogen molecules and thereby embrittle the SC alloy lump. The second stage is the fine pulverization in which the coarse powder obtained by the coarse pulverization is ground into fine powder with a jet mill. In general, after the hydrogen pulverization has been completed, the coarse powder is heated to approximately 500° C. to remove hydrogen from the powder (dehydrogenation heating). However, it is preferable to omit the dehydrogenation heating and utilize the heat in the sintering process to remove the hydrogen. The reason for this will be explained later.

In the filling process 112, a mold is filled with the alloy powder obtained in the alloy powder preparation process 111. Subsequently, in the orienting process 113, a magnetic field is applied to the alloy powder in the mold to orient the particles of the alloy powder in one direction. In this process, no mechanical pressure for the shaping is applied to the alloy powder.

After that, the alloy powder as held in the mold is heated to a sintering temperature (e.g. a temperature within a range of 900-1100° C.), with no mechanical pressure for the shaping applied to it, to obtain the base material (sintering process 114). When the temperature increases due to this heating, the carbon which is present as an impurity in the alloy powder reacts with the hydrogen which remains unremoved after the hydrogen pulverization, to form CH₄ gas, whereby both carbon and hydrogen are removed. Such a technique of removing the carbon as an impurity is also used in Patent Literature 1. According to this literature, the concentration of the carbon remaining in the base material can be decreased to 1000 ppm or lower levels by this technique.

The base material obtained in this manner is the result of a proportional shrinkage of the alloy powder in the mold during the sintering process, and therefore, has a shape corresponding to the shape of the inner space of the mold. The shrinkage ratio in the sintering process depends on the volume filling factor of the alloy powder in the mold. For example, if the volume filling factor is approximately 50%, the shrinkage ratio is approximately 35% in the direction of the magnetic field applied in the orienting process and approximately 15% in the orthogonal direction to that direction. By determining the dimensions of the inner space of the mold taking into account these shrinkage ratios, a base material with the smallest-size portion being equal to or greater than 3 mm in size (thickness) can be obtained.

The grain boundary diffusion process 12 is subdivided into the heavy-rare-earth-element-containing application material preparation process 121, applying process 122, and material-applied base material heating process 123 (FIG. 1). The heavy-rare-earth-element-containing application material preparation process 121 can be performed concurrently with or before the base material production process 11.

In the heavy-rare-earth-element-containing application material preparation process 121, an application material containing a heavy rare-earth element R^{H} is prepared. As the application material, a heavy-rare-earth-element-containing application material prepared by mixing a powder containing a heavy rare-earth element R^{H} and a paste of organic substance is preferable, because this type of application material can satisfactorily come in contact with the base material and is difficult to be removed from the surface of the base material even when a considerable amount of application material is applied to the surface. The satisfactory contact between the paste-like application material and the base material also provides the advantage that the heavy rare-earth element R^{H} in the application material can be easily diffused into the base material during the material-applied base material heating process 123. As the powder containing the heavy rare-earth element R^{H}, for example, a powder of the simple metal of the heavy rare-earth element R^{H}, an alloy or intermetallic compound containing the heavy rare-earth element R^{H}, or a mixture of any of these kinds of powder with a different kind of metallic powder can be used.

In the applying process 122, the application material prepared in the previously described manner is applied to the surface of the base material. The amount of the material to be applied is previously determined by a preliminary experiment so that the amount of heavy rare-earth element R^{H} contained in the RFeB system sintered magnet divided by the volume of the same RFeB system sintered magnet after the grain boundary diffusion treatment becomes equal to or greater than 25 mg/cm³. In the case where the entire amount of adhered heavy rare-earth element R^{H} in the application material is diffused into the RFeB system sintered magnet by the grain boundary diffusion treatment, the amount of application material is controlled so that the amount of heavy rare-earth element R^{H} in the application material divided by the volume of the RFeB system sintered magnet becomes equal to or greater than 25 mg/cm³. In this case, since the volume of the RFeB system sintered magnet after the grain boundary diffusion treatment normally remains unchanged from the volume of the base material, the aforementioned amount can be defined using the volume of the base material in place of the volume of the RFeB system sintered magnet.

In the material-applied base material heating process 123, the base material with the application material applied is heated to a predetermined temperature (e.g. 700-950° C.) in a vacuum or inert-gas atmosphere to diffuse the heavy rare-earth element R^{H} through the grain boundaries. Subsequently, the application material (adhesion material) remaining on the surface of the base material is removed.

By the production method described to this point, the RFeB system sintered magnet according to the present invention can be produced.

### Example

Hereinafter described are actually produced examples of the RFeB system sintered magnet as well as the results of experiments performed for the produced RFeB system sintered magnets.

In the present example, an SC alloy lump was used as the material for the base material. The SC alloy lump had a composition of 25.9% by mass of Nd, 4.11% by mass of Pr, 0.96% by mass of B, 0.89% by mass of Co, 0.10% by mass of Cu, and 0.27% by mass of Al, with Fe as the balance. No heavy rare-earth element R^{H} was contained in the alloy. In the alloy powder preparation process 111, this SC alloy lump was pulverized into alloy powder by the coarse pulverization using hydrogen pulverization, followed by the coarse pulverization using a jet mill, until the particle size as measured by a laser method was decreased to 3 μm in terms of the median value. No dehydrogenation heating was performed between the coarse pulverization and the sintering process.

In the filling process 112, a plurality of molds having a rectangular-parallelepiped inner space with various thicknesses equal to or greater than 5 mm were filled with the obtained alloy powder. The alloy powder held in each mold was oriented by a pulsed magnetic field with a strength of 5 T or higher in the orienting process 113, and subsequently sintered at 980° C. in the sintering process 114. In this manner, a plurality of kinds of rectangular-parallelepiped base bodies 20 (FIG. 2A) with thicknesses t of 3 mm, 6 mm, 8 mm and 10 mm, respectively, were produced. As noted earlier, in the present example, the sintering process was carried out without performing the dehydrogenation heating. Therefore, the carbon content in the base material is suppressed to 1000 ppm or lower levels. An actually measured value of the carbon content in the produced base material was 400 ppm. The carbon content in the base material may also be decreased by other methods, e.g. by modifying the process condition, such as the kind and/or amount of additive or the sintering condition.

Since the base material 20 has a rectangular-parallelepiped shape, the smallest-size portion 22 is defined at an arbitrary position on a pair of mutually facing surfaces 21 having the smallest inter-surface distance. In the case of the base material 20A which has curved surfaces 21A as shown in FIG. 2B, the smallest-size portion 22A is defined at a specific position. Although the present description about the smallest-size portion is concerned with the base material, the smallest-size portion can also be similarly defined in the RFeB system sintered magnet obtained as the final product.

The grain boundary diffusion process 12 was performed as follows: In the heavy rare-earth-element-containing application material preparation process 121, a powder of Tb(R^{H})-containing alloy having a composition of 92.0% by mass of Tb, 4.3% by mass of Ni and 3.7% by mass of Al was mixed with silicone grease in a mass ratio of 4:1 to obtain a paste (application material). In the applying process 122, this application material was applied to each of the two mutually facing surfaces 21 in an amount of 14 mg per unit area (1 cm²). In the material-applied base material heating process 123, the base material with the application material was heated at 900° C. for 10 hours. Subsequently, the temperature was lowered to 500° C. and maintained for 1.5 hours. In this manner, the RFeB system sintered magnets of the present examples and those of the comparative examples were individually produced. The difference between the present and comparative examples is hereinafter described.

If the thickness t of each base material is d mm=(0.1d) cm, the amount of heavy rare-earth element R^{H} per unit volume (1 cm³) of the base material is 14 mg/cm²×2×0.8 (mass ratio of the alloy in the application material)×0.92 (mass ratio of Tb in the alloy)/((0.1d) cm)=(206.08/d) mg/cm³. Accordingly, the thickness t of each base material and the amount of heavy rare-earth element R^{H} per unit volume are as shown in Table 1.

TABLE 1
Thickness and Amount of Heavy Rare-
Earth Element R^{H} per Unit Volume

| | | | | Comparative |
|---|---|---|---|---|
| | Comparative | | | Example 2 |
| | Example 1 | Present | Present | (Amount of R^{H} |
| | (Prior Art) | Example 1 | Example 2 | Insufficient) |
| Base Material | 3 | 6 | 8 | 10 |
| Thickness t [mm] | | | | |
| Amount of Heavy | 68.69 | 34.35 | 25.76 | 20.61 |
| Rare-Earth | | | | |
| Element R^{H} per | | | | |
| Unit Volume | | | | |
| [mg/cm³] | | | | |

Note:
The amount of paste (per unit area) applied to one face of the base material was 14 mg/cm².

In Table 1, the base material in Comparative Example 1 was sufficiently thin and the heavy rare-earth element R^{H} could be distributed over the entire base material even by the conventional method. In Comparative Example 2, the amount of heavy rare-earth element R^{H} per unit volume in the RFeB system sintered magnet was smaller than the range specified in the present invention.

For each obtained sample, the overall coercivity H_{cj} and residual magnetic flux density Bᵣ of the RFeB system sintered magnet were measured with the PBH-1000 system manufactured by Nihon Denji Sokki Co., Ltd. Table 2 shows the measured result. Table 2 also shows, in the round brackets, the coercivity H_{cj} and residual magnetic flux density Bᵣ in the base bodies used for the respective samples.

TABLE 2
Magnetic Properties of Samples (and those
of Base Bodies Used, in Brackets)

| | | | Residual |
|---|---|---|---|
| | Base Material | | Magnetic |
| | Thickness t [mm] | Coercivity | Flux Density |
| | (shown above) | H_{cj} [kOe] | Bᵣ [kG] |
| Comparative | 3 | 25.42 (14.56) | 13.82 (14.06) |
| Example 1 | | | |
| Present Example 1 | 6 | 24.78 (16.44) | 13.71 (13.88) |
| Present Example 2 | 8 | 23.17 (16.33) | 13.67 (13.80) |
| Comparative | 10 | 22.03 (16.29) | 13.43 (13.52) |
| Example 2 | | | |

The overall coercivity of the RFeB system sintered magnets decreased with a decrease in the amount of heavy rare-earth element R^{H} per unit volume. However, a sufficiently high value which exceeds 20 kOe was achieved by any of the samples. As for the residual magnetic flux density, the difference from the value obtained with the base material was within the range from 0.09 to 0.24 kG (less than 2%) in any of the samples. This result demonstrates that the decrease in the residual magnetic flux density due to the presence of the heavy rare-earth element R^{H} barely occurred. Thus, as far as the overall magnetic properties of the RFeB system sintered magnet are concerned, satisfactory values were obtained in both present and comparative examples.

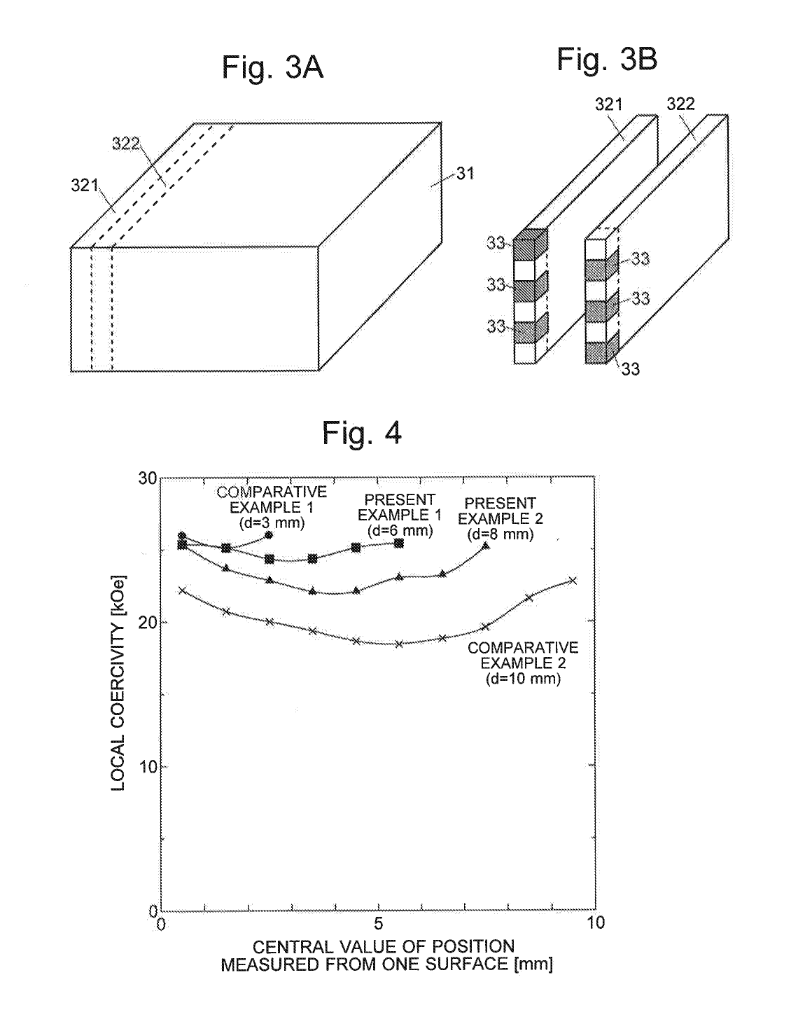

For each of the RFeB system sintered magnets of the present and comparative examples, the local coercivity was measured as follows: Initially, two RFeB system sintered magnet sheets 321 and 322 with a thickness of 1 mm were sliced from the RFeB system sintered magnet 31, with the cutting plane perpendicular to the surfaces of the smallest-size portion (FIG. 3A). Subsequently, RFeB system sintered magnet pieces 33 in a 1-mm cubic form were cut out from the first RFeB system sintered magnet sheet 321 (FIG. 3B), with one piece from each of the following ranges as measured by the distance from one surface of the smallest-size portion of the RFeB system sintered magnet 31: 0 mm to 1 mm; 2 mm to 3 mm; 4 mm to 5 mm (exclusive of Comparative Example 1); 6 mm to 7 mm (only Present Example 2 and Comparative Example 2); and 8 mm to 9 mm (only Comparative Example 2). RFeB system sintered magnet pieces 33 in a 1-mm cubic form were also cut out from the first RFeB system sintered magnet sheet 322 (FIG. 3B), with one piece from each of the following ranges as measured by the distance from the aforementioned surface: 1 mm to 2 mm; 3 mm to 4 mm (exclusive of Comparative Example 1); 5 mm to 6 mm (exclusive of Comparative Example 1); 7 mm to 8 mm (only Present Example 2 and Comparative Example 2); and 9 mm to 10 mm (only Comparative Example 2). Accordingly, in each of the two RFeB system sintered magnet sheets 321 and 322, the sections from which the RFeB system sintered magnet pieces 33 were cut out were arranged in the thickness direction of the RFeB system sintered magnet 31 with a gap of 1 mm in between. By providing the gaps in this manner as the cutting margin for the thickness of the cutting knife, each RFeB system sintered magnet piece 33 is prevented from being encroached by the cutting margin. Additionally, since the two RFeB system sintered magnet sheets 321 and 322 mutually have a 1-mm displacement of the sections from which the RFeB system sintered magnet pieces 33 are cut out, the RFeB system sintered magnet pieces 33 are obtained at intervals of 1 mm in the thickness direction with no gap in between.

The coercivity of each of the RFeB system sintered magnet pieces 33 obtained in the present and comparative examples was measured with a high sensitivity VSM (Vibrating Sample Magnetometer) manufactured by Tamakawa Co., Ltd. The graph in FIG. 4 shows the measured result.

In this graph, the local coercivity in Present Example 1 was 24.35 kOe within the range of 2-3 mm from one (first) surface, and 24.36 kOe within the range of 3-4 mm. From these two values, it is possible to estimate that the local coercivity at the center of the smallest-size portion, i.e. at 3 mm from the first surface, was 24.35 kOe. Meanwhile, the local coercivity at the first surface of the RFeB system sintered magnet in Present Example 1 was 25.37 kOe, while the value at the other (second) surface was 25.42 kOe. Accordingly, the difference between the local coercivity at the surface of the smallest-size portion of the RFeB system sintered magnet and the local coercivity in the central region of the same portion was 0.07 kOe when the surface with the larger difference was chosen. This difference value corresponds to approximately 0.3% of the local coercivity at the surface and is sufficiently lower than 15%. The lowest value of the local coercivity in Present Example 1 was 25.13 kOe, which was observed within the range of 1-2 mm as well as 4-5 mm from the first surface, while the highest value of the local coercivity was 25.42 kOe, which was recorded on the second surface of the smallest-side portion. The difference between the highest and lowest values of the local coercivity was approximately 1.1% of the highest value of the local coercivity, i.e. ((25.42−25.13)/25.42)×100=1.14 . . . .

Analyzing the Present Example 2 in a similar manner to Present Example 1 yields the following result: At the two positions before and after the central point which was at 4 mm from the first surface of the smallest-size portion in the RFeB system sintered magnet of Present Example 2, the local coercivity was 22.08 kOe (at a point within 3-4 mm from the first surface) and 22.11 kOe (4-5 mm), respectively. The local coercivity at the first surface was 25.36 kOe, while that of the second surface was 25.18 kOe. Accordingly, the largest difference between the local coercivity at the surface of the smallest-size portion of the RFeB system sintered magnet and the local coercivity in the central area is (25.36-22.08)=3.28 kOe. This difference corresponds to approximately 12.9% of the local coercivity at the surface, i.e. (3.28/25.36)×100=12.93 . . . .

By comparison, analyzing the Comparative Example 2 yields the following result: At the two positions before and after the central point which was at 5 mm from the first surface of the smallest-size portion in the RFeB system sintered magnet of Comparative Example 2, the local coercivity was 18.66 kOe (at a point within 4-5 mm from the first surface) and 18.46 kOe (5-6 mm), respectively. The local coercivity at the first surface was 22.20 kOe, while that of the other surface was 22.78 kOe. Accordingly, the smallest difference between the local coercivity at the surface of the smallest-size portion of the RFeB system sintered magnet and the local coercivity in the central area is 22.20-18.66=3.54 kOe. This difference corresponds to approximately 15.9% of the local coercivity at the surface, i.e. (3.54/22.20)×100=15.94 . . . . Therefore, the RFeB system sintered magnet in Comparative Example 2 is not included within the scope of the present invention.

In Patent Literature 1, a paste which contains TbNiAl alloy powder having the same composition as the present examples, with silicone grease mixed in the same ratio as the present examples, is applied to each of the two mutually facing surfaces of base bodies with thicknesses of 6 mm and 10 mm in an amount of 10 mg/cm² to perform the grain boundary diffusion treatment. In this case, the amount of heavy rare-earth element R^{H} contained in the paste divided by the volume of the base material is 24.5 mg/cm³ for the 6-mm-thick base material and 14.7 mg/cm³ for the 10-mm-thick base material. Therefore, the RFeB system sintered magnet and its production method described in Patent Literature 1 are not included within the scope of the present invention.

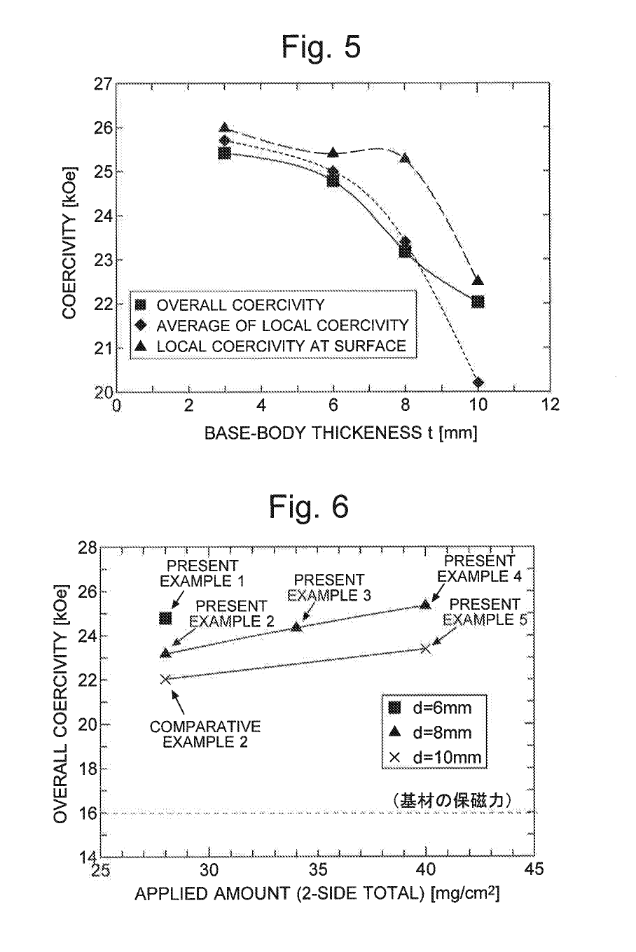

The graph in FIG. 5 shows the overall coercivity, average of all measured values of the local coercivity, and local coercivity at the sample surface (average value of the two surfaces) for each of the samples produced in Present Examples 1 and 2 as well as Comparative Examples 1 and 2. From this graph, it is possible to consider that the average value of the local coercivity is approximately equal to the overall coercivity in Present Examples 1 and 2 as well as Comparative Example 1. By comparison, in the case of the sample in Comparative Example 2 produced from the base material having the largest thickness, the average value of the local coercivity is lower than the overall coercivity. These results demonstrate that the local coercivity in Present Examples 1 and 2 (as well as Comparative Example 1 in which the base material was thinner than in the other examples) is more uniform than in Comparative Example 2.

Additionally, another experiment was performed (Present Examples 3-5) in which the paste was applied to the base bodies with thicknesses of 8 mm and 10 mm in larger amounts than in Present Example 2 and Comparative Example 2. The experimental conditions were as shown in Table 3.

TABLE 3
Conditions of Experiment with Different Amount of Paste
Applied per Unit Area on Surface of Base Material

| | Present | Present | Present |
|---|---|---|---|
| | Example 3 | Example 4 | Example 5 |
| Base Material | 8 | 8 | 10 |
| Thickness t [mm] | | | |
| Amount of Paste | 17 | 20 | 20 |
| Applied per Unit Area | | | |
| on Surface of Base | | | |
| Material (on One Side) | | | |
| [mg/cm²] | | | |
| Amount of Heavy | 31.28 | 36.80 | 29.44 |
| Rare-Earth | | | |
| Element R^{H} per | | | |
| Unit Volume | | | |
| [mg/cm³] | | | |

The graph in FIG. 6 shows the measured result of the overall coercivity of the RFeB system sintered magnets in Present Examples 1-5 as well as Comparative Example 2. Even when the base material having the largest thickness of 10 mm is used, the overall coercivity can be increased to be as high as in the case of using a thinner base material by increasing the amount of applied paste so that the amount of heavy rare-earth element R^{H} per unit volume of the base material exceeds 25 mg/cm³ (Present Example 5). A comparison of Present Examples 2, 3 and 4 in which the 8-mm-thick base material was used demonstrates that the overall coercivity increases with an increase in the amount of applied paste.

In the previously described examples, Tb was used as an example of the heavy rare-earth element R^{H}. It is possible to use Dy or Ho as the heavy rare-earth element R^{H}. A mixture of two or three of the three mentioned elements may also be used.

### REFERENCE SIGNS LIST

11 . . . Base Material Production Process
111 . . . Alloy Powder Preparation Process
112 . . . Filling Process
113 . . . Orienting Process
114 . . . Sintering Process
12 . . . Grain Boundary Diffusion Process
121 . . . Heavy-Rare-Earth-Element-Containing Application Material Preparation Process
122 . . . Applying Process
123 . . . Material-Applied Base Material Heating Process
20, 20A . . . Base Material
21, 21A . . . Mutually-Facing Surfaces with Smallest Inter-Surface Distance
22, 22A . . . Smallest-Size Portion
31 . . . RFeB System Sintered Magnet
321, 322 . . . RFeB System Sintered Magnet Sheet
33 . . . RFeB System Sintered Magnet Piece

1. An RFeB system sintered magnet in which a heavy rare-earth element R^{H} which is at least one kind of rare-earth element selected from a group of Dy, Tb and Ho is diffused into a base material through grain boundaries of the same base material made of a sintered compact of an RFeB system magnet containing R^{L}, Fe and B, where R^{L} represents a light rare-earth element which is at least one kind of rare-earth element selected from a group of Nd and Pr, wherein:
a size of the RFeB system sintered magnet at a smallest-size portion is greater than 3 mm;
an amount of heavy rare-earth element R^{H} contained in the RFeB system sintered magnet divided by a volume of the RFeB system sintered magnet is equal to or greater than 25 mg/cm³; and
a difference between a local coercivity at a surface of the smallest-size portion and a local coercivity in a central region of the smallest-size portion is equal to or less than 15% of the local coercivity at the surface.

2. The RFeB system sintered magnet according to claim 1, wherein a carbon content is equal to or lower than 1000 ppm.

3. An RFeB system sintered magnet production method, comprising:
a) a base material creation process in which a base material made of a sintered compact of an RFeB system magnet containing R^{L}, Fe and B is created, where R^{L} represents a light rare-earth element which is at least one kind of rare-earth element selected from a group of Nd and Pr, and a size of the sintered compact at a smallest-size portion is greater than 3 mm; and
b) a grain boundary diffusion process in which a grain boundary diffusion treatment is performed including a step of adhering, to a surface of the base material, an adhesion material containing a heavy rare-earth element R^{H} which is at least one kind of rare-earth element selected from a group of Dy, Tb and Ho, and a step of heating the adhesion material, where an amount of heavy rare-earth element R^{H} contained in the adhesion material is controlled so that an amount of heavy rare-earth element R^{H} contained in the RFeB system sintered magnet divided by a volume of the same RFeB system sintered magnet after the grain boundary diffusion treatment becomes equal to or greater than 25 mg/cm³.

4. The RFeB system sintered magnet production method according to claim 3, wherein a content of carbon in the base material is equal to or lower than 1000 ppm.

5. The RFeB system sintered magnet production method according claim 3, wherein the base material is created by filling a mold with an alloy powder containing the light rare-earth element R^{L}, Fe and B as a raw material, orienting the alloy powder by applying a magnetic field without applying mechanical pressure for shaping, and sintering the alloy powder by heating the same powder as contained in the mold without applying mechanical pressure for shaping.

6. The RFeB system sintered magnet production method according to claim 4, wherein the base material is created by filling a mold with an alloy powder containing the light rare-earth element R^{L}, Fe and B as a raw material, orienting the alloy powder by applying a magnetic field without applying mechanical pressure for shaping, and sintering the alloy powder by heating the same powder as contained in the mold without applying mechanical pressure for shaping.
